(19) United States
(12) Patent Application Publication
(10) Pub. No.: US 2012/0244931 A1
(43) Pub. Date: Sep. 27, 2012

(54) RESPONSIBLE GAMING DEVICES AND RELATED METHODS

(75) Inventors: Carmen DiMichele, Sparks, NV (US); James W. Morrow, Sparks, NV (US)

(73) Assignee: BALLY GAMING, INC, Las Vegas, NV (US)

(21) Appl. No.: 13/476,718

(22) Filed: May 21, 2012

Related U.S. Application Data
(63) Continuation of application No. 11/938,248, filed on Nov. 9, 2007.

(51) Int. Cl. A63F 13/12; A63F 9/24

(52) U.S. Cl. 463/25; 463/42; 463/41

(57) ABSTRACT

Various methods of promoting responsible gaming are disclosed herein. According to one method, a communication unit is connected to each gaming device for providing communication between the gaming devices and a back-end server over a communication network and with networks providing one or more of Internet or cellular phone communication. Play at the gaming device is monitored and when a responsible message trigger condition occurs, a message is sent over one more of the cellular telephone or Internet communication networks to one or more recipients. The unit may be enabled to receive input from a player's cellular telephone or PDA.

### CROSS-REFERENCE TO RELATED APPLICATIONS

This application is a continuation of U.S. patent application Ser. No. 11/938,248 filed Nov. 9, 2007 and titled “RESPONSIBLE GAMING DEVICES AND RELATED METHODS which is hereby incorporated by reference.

This application is related to co-pending U.S. patent application Ser. No. 11/938,251 concurrently filed on Nov. 9, 2007, entitled RESPONSIBLE GAMING DEVICES.

### COPYRIGHT NOTICE

A portion of the disclosure of this patent document contains material that is subject to copyright protection. The copyright owner has no objection to the facsimile reproduction by any one of the patent document or the patent disclosure, as it appears in the Patent and Trademark Office patent files or records, but otherwise reserves all copyright rights whatsoever.

### BACKGROUND

Gaming devices have been developed that have various features designed to capture and maintain player interest. For example, the mechanical reels of traditional gaming devices have been replaced with video depictions of spinning reels. These video gaming devices provide a richer gaming experience for players by including graphics or animation as part of the game. Moreover, gaming devices have been developed to provide a greater gaming experience with sound effects, animation, and the like.

In addition to providing a greater gaming experience, gaming devices provide added convenience to allow for longer gaming sessions. For example, multi-denomination gaming devices allow a player to select the wager denomination used in game play. Accordingly, a player does not need to change devices to play different wager denominations. Additionally, most gaming devices include bill and voucher acceptors that allow a player to easily initiate a game. That is, a player does not need to get or to make change to play a particular gaming machine. While these gaming device features both enhance the gaming experience and simplify the gaming experience, what is needed are gaming machines that also promote responsible gaming.

### SUMMARY

Briefly, and in general terms, various methods of promoting responsible gaming are disclosed herein. According to one method, the gaming device receives player input initiating a gaming session. A timer is then initiated in response to the start of a gaming session, and a responsible gaming message is presented to a player at predetermined time intervals.

According to another method, the gaming device receives player input to initiate a gaming session. A responsible gaming message is presented to a player in response to a predetermined trigger event, wherein the trigger event is a predefined period of time, cumulative win amount, cumulative loss amount, or any combination thereof.

In yet another method, a gaming device receives a player wager, and contributes a portion of the player wager to a charitable donation pool. During the gaming session, a running total of the charitable donation pool is presented on a display to a player.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 is a perspective view of one embodiment of a responsible gaming device;

FIG. 2 is one embodiment of a screen shot of a responsible gaming message;

FIG. 3 is another embodiment of a screen shot of a responsible gaming message;

FIG. 4 is a diagrammatic representation of one embodiment of a responsible gaming module;

FIG. 5 is a flow chart of one method of promoting responsible gaming on a gaming device;

FIG. 6 is a perspective view of another embodiment of a responsible gaming device; and

FIG. 7 is a diagram of one embodiment of a gaming system including one or more responsible gaming devices.

### DETAILED DESCRIPTION

Various embodiments are directed to responsible gaming devices. According to one embodiment, the responsible gaming device presents a message asking if the player would like to pause and/or end a gaming session. In alternate embodiments, the gaming device may also send a message to a casino employee to visit a player to inquire if the player would like to terminate the gaming session. In yet another embodiment, the gaming device notifies one or more of the player's contacts that the player has been presented a message to pause and/or end a gaming session. Accordingly, the player's contact then may visit the player and encourage the player to pause and/or end the gaming session. In another embodiment, the gaming device includes a display that presents the player's performance (number of wins and losses, percentage of wins, or the like) in addition to a message to end a gaming session. Accordingly, the player is able to know his performance in order to decide whether to pause and/or end a gaming session.

In another embodiment, a responsible gaming device contributes a portion of a player's wager to a charity. At the end of the gaming session, the player is given a tax deduction receipt in the amount of the player's contribution to the charity. In one embodiment, the player is given the option to contribute to the charity or alter the percentage of the wager donated to the charity. In one embodiment, the responsible gaming device matches the player's donation to the charity.

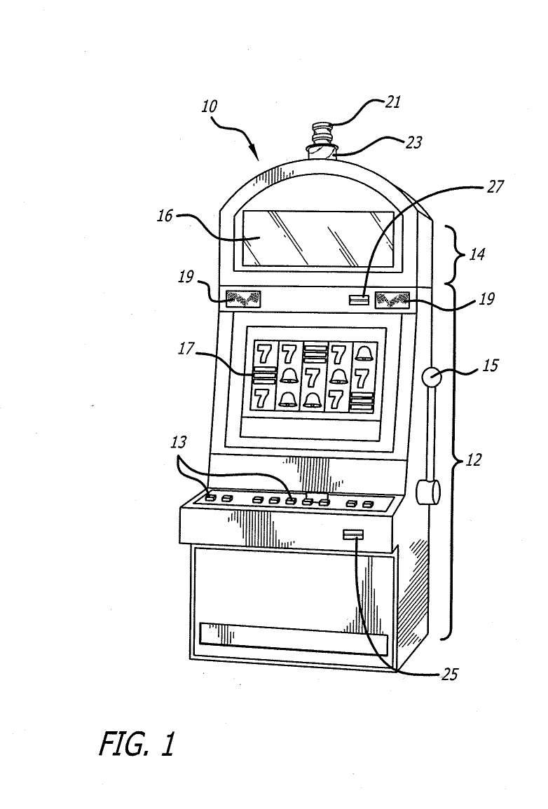

Referring now to the drawings, wherein like reference numerals denote like or corresponding parts throughout the drawings and, more particularly to FIGS. 1-4, there are shown various embodiments of a responsible gaming device. More specifically, as shown in FIG. 1, the gaming device 10 includes a gaming cabinet 12 and a top box 14. The gaming device 10 also includes various player input devices 13, 15 to play one or more games presented on a main display 17.

Referring back to FIG. 1, the main cabinet 12 of the gaming device 10 is a self-standing unit that is generally rectangular in shape. Alternatively, in other embodiments, the gaming cabinet may be a slant-top gaming cabinet or any shaped cabinet known or developed in the art. Additionally, the cabinet may be manufactured with reinforced steel or other rigid materials that are resistant to tampering and vandalism. Optionally, in an alternate embodiment, the gaming device 10 may instead be a cinema-style gaming device (not shown) having a widescreen display, as disclosed in U.S. application Ser. No. 11/225,827, entitled “Ergonomic Gaming Cabinet,” filed on Sep. 12, 2005, which is hereby incorporated by reference.

As shown in FIG. 1, the gaming device 10 includes a main display 17. According to one embodiment, the main display 17 is a plurality of mechanical reels for presenting a slot-style game. Alternatively, the main display 17 is a video display for presenting one or more games such as, but not limited to, mechanical slots, video slots, video keno, video poker, video blackjack, video roulette, Class II bingo, games of skill, games of chance involving some player skill, or any combination thereof.

According to yet another embodiment, the main display 17 is a widescreen display (e.g., 16:9 or 16:10 aspect ratio display). In one embodiment, the display 17 is a flat panel display including by way of example only, and not by way of limitation, liquid crystal, plasma, electroluminescent, vacuum fluorescent, field emission, LCOS (liquid crystal on silicon), and SXRD (Silicon Xtal Reflective display), or any other type of panel display known or developed in the art. These flat panel displays may use panel technologies to provide digital quality images including by way of example only, and not by way of limitation, EDTV, HDTV, or DLP (Digital Light Processing). The widescreen display 17 may be mounted in the gaming cabinet 12 in a portrait or landscape orientation. In another embodiment, the game display 17 may also include a touch screen or touch glass system (not shown). The touch screen system allows a player to input choices without using any electromechanical buttons 13. Alternatively, the touch screen system may be a supplement to the electromechanical buttons 13.

According to one embodiment, the top box 14 is a separate and distinct component that is affixed to the main cabinet 12. In another embodiment, the top box 14 is an area that is partitioned from the main cabinet 12. Alternatively, the top box 14 and the main cabinet 12 may be contiguous areas with the outward appearance of two distinct components. According to one embodiment, the top box 14 includes a display glass. The display glass may include the name of the game, artwork, game instructions, pay table, or other information relating to the game.

According to another embodiment, the top box 14 includes a secondary display for displaying game information (e.g., name of the game, game marquee, animation, one or more pay tables, game information, one or more help menus, one or more secondary games, progressive jackpot information or tournament game information) or non-game related information (e.g., news, advertisements, messages or promotions). The secondary display 16 may be a flat panel display, dot matrix display, cathode ray tube display, display glass, backlit display glass, diorama, three-dimensional relief, pachinko-style secondary game, one or more wheels, one or more mechanical reels, or a combination thereof. The display 16 may have a wide screen aspect ratio (4:3, 16:9, 16:10 or the like) and the display may or may not include a touch screen or other touch device associated therewith. Optionally, the secondary display is movable (e.g., tilted a few degrees downward or upward) so that the display is more easily viewed by a casino patron. The movement of the display may be done manually or automatically (e.g., motor or linear actuator).

Additionally, as shown in FIG. 1, the top box 14 includes a candle 21 having three tiers. As those skilled in the art will appreciate, other embodiments of the candle 21 may include one or more tiers. The tiers may be jointly or individually illuminated with one or more incandescent light bulbs or light emitting diodes (LEDs). In one embodiment, the bottom tier 23 of the candle 21 includes a plurality of multi-colored LEDs. Additionally, a plurality of LED reflectors (not shown) is provided within the bottom tier 23 of the candle 21. For example, in one embodiment, eight reflectors are provided within the bottom tier in an octagonal configuration (when viewed from above). Accordingly, the LEDs in the bottom tier 23 of the candle 21 may be alternately illuminated (in the same or different colors) around the circumference of the bottom tier to simulate a rotating light. Alternatively, the LEDs may flash in one or more colors. Accordingly, the LEDs in the bottom tier 23 of the candle 21 may be programmed to illuminate when a responsible gaming message is presented to the player or a jackpot is triggered. The lights in the top tiers of the candle 21 may be illuminated to signal that player needs assistance from a casino floor employee, a jackpot has been won, or that a responsible gaming message has been presented to a player.

As shown in FIG. 1, the gaming device 10 includes a plurality of player-activated buttons 13. These buttons 13 may be used for various functions such as, but not limited to, selecting a wager denomination, selecting a number of games to be played, selecting the wager amount per game, initiating a game, or cashing out money from the gaming device 10. The buttons 13 function as input mechanisms and may include mechanical buttons, electromechanical buttons or touch screen buttons. In another embodiment, one input mechanism is a universal button module that provides a dynamic button system adaptable for use with various games, as disclosed in U.S. application Ser. No. 11/106,212, entitled “Universal Button Module”, filed Apr. 14, 2005 and U.S. application Ser. No. 11/223,364, entitled “Universal Button Module”, filed Sep. 9, 2005, which are both hereby incorporated by reference. Additionally, other input devices, such as but not limited to, touch pad, track ball, mouse, switches, and toggle switches, are included with the gaming device to also accept player input. Optionally, a handle 15 may be “pulled” by a player to initiate a slots-based game.

In an alternate embodiment, a cellular phone or other input device (e.g., PDA), separate and apart, from the gaming device 10 may also be used to input various player choices and information to enhance the player's interactive experience with the gaming device. Furthermore, inputting information via these devices provides an added level of security as any key presses may be hidden from view. In yet another embodiment, a player may call or send a text message or a short message service (SMS) to the gaming device.

As shown in FIG. 1, the gaming device 10 includes a ticket reader/ticket printer slot 25 that is associated with a cashless gaming system (not shown). As shown in FIG. 1, a single slot 25 is used for the ticket reader and ticket printer. Accordingly, the same slot 25 may be used to insert and/or issue a ticket. However, in alternate embodiments, separate slots (not shown) may be provided for the ticket acceptor and the ticket printer. In one embodiment, the ticket reader (not shown) of the cashless gaming system is capable of accepting previously printed vouchers, paper currency, promotional coupons, or the like. The ticket printer (not shown) of the cashless gaming system generates vouchers having printed information that includes, but is not limited to, the value of the voucher (i.e., cash-out amount) and a barcode that identifies the voucher. In yet another embodiment, the ticket printer generates tax receipts for charitable donations made on the responsible gaming device.

Additionally, the gaming device includes a player tracking system (not shown). The player tracking system allows a casino to monitor the gaming activities of various players. Additionally, the player tracking system is able to store data relating to a player's gaming habits. That is, a player can accrue player points that depend upon the amount and frequency of their wagers. Casinos can use these player points to compensate the loyal patronage of players. For example, casinos may award (or “comp”) a player with free meals, room accommodations, tickets to shows, and invitations to casino events and promotional affairs.

Typically, the player tracking system is operatively connected to one or more input components on the gaming device 10. These input components include, but are not limited to, a slot 27 for receiving a player tracking card, a keypad or equivalent, an electronic button receptor, a touch screen and the like. The player tracking system may also include a database of all qualified players (i.e., those players who have enrolled in a player rating or point accruing program). Generally, the database for the player tracking system is separate from the gaming devices.

In another embodiment, the gaming device 10 includes an internet connection or other known network connections to link one or more gaming devices together. According to one embodiment, the internet connection is used for web browsing, prize redemption, or access to other gaming or non-gaming information. Additionally, with the various gaming devices in communication with one another (or a system host), the gaming device 10 may participate in a gaming tournament. In one embodiment, the gaming tournament is a competitive gaming tournament having one (or a few) winners. Alternatively, the gaming tournament is a cooperative gaming tournament where all eligible gaming devices win a particular award.

One of ordinary skill in the art will appreciate that not all gaming devices have all these components and that the gaming devices may have other components in addition to, or in lieu of, those components mentioned here. Furthermore, while these components are viewed and described separately, various components may be integrated into a single unit in some embodiments.

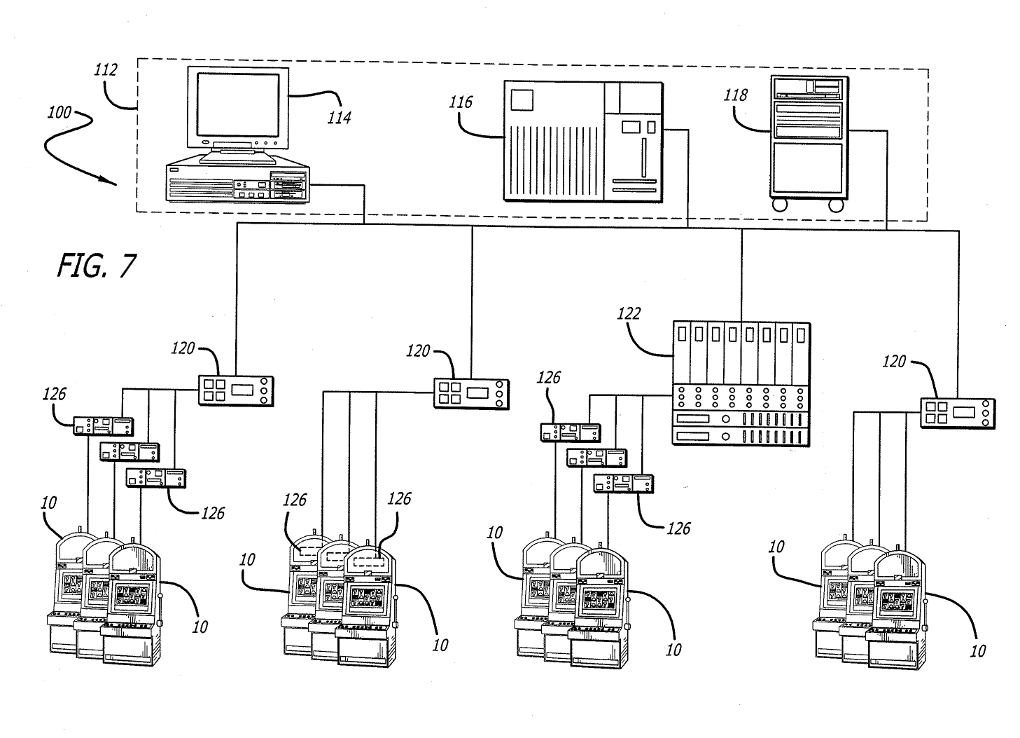

Referring now to FIG. 7, a casino gaming system 100 is illustrated. The casino gaming system 100 comprises one or more gaming devices 10. In various embodiments, any of the gaming devices 10 may be any type of electronic or mechanical gaming devices, such as, but not limited to, a mechanical reel spinning slot device, video slot device, video poker device, keno device, video blackjack device, or a gaming device offering one or more of the above-described games. Examples include, but are not limited to, the 56000 mechanical reel spinner and the Alpha video slot device from Bally Technologies, Inc. The gaming devices 10, 20 illustrated in FIG. 7 act as terminals for interacting with a player playing a casino game. Networking components facilitate communications between the system server 112 and game management units 126 that control displays for carousels of gaming devices 10 across a network 740. Game management units (GMU's) 126 connect gaming devices to networking components and may be installed in the gaming device cabinet or external to the gaming device 10. The function of the GMU 126 is similar to the function of a network interface card connected to a desktop personal computer (PC). Some GMU's 126 have much greater capability and can perform such tasks as presenting and playing a game using a display (not shown) operatively connected to the GMU 126. In one embodiment, the GMU 126 is a separate component located outside the gaming device 10. Alternatively, in another embodiment, the GMU 126 is located within the gaming device 10. Optionally, in an alternative embodiment, one or more gaming devices 10 connect directly to a network and are not connected to a GMU 126.

Furthermore, one or more of the gaming devices 10 includes one or more data repositories for storing data. Examples of information stored by the gaming devices 10 include, but are not limited to, accounting data, maintenance history information, short and/or long-term play data, real-time play data, and sound data. The sound data may include, but is not limited to, audio files, sound clips, way files, mp3 files and sound files saved in various other formats. Furthermore, each gaming device 10 comprises an audio system (not shown) for outputting sound.

The gaming devices 10 are connected via a network to a network bridge 120, which is used for networking, routing and polling gaming devices, including slot devices. The network bridge 120 connects to a back end system 112. Optionally, the gaming devices 10 may connect to the network via a network rack 122, which provides for a few numbers of connections to the back end system 112. Both network bridge 120 and network rack 122 may be classified as middleware, and facilitate communications between the back end system 112 and the game management units 126. The network bridges 120 and network rack 122 may comprise data repositories for storing network performance data. Such performance data may be based on network traffic and other network related information. Optionally, the network bridge 120 and the network rack 122 may be interchangeable components. For example, in one embodiment, a casino gaming system may comprise only network bridges and no network racks. Alternatively, in another embodiment, a casino gaming system may comprise only network racks and no network bridges. Additionally, in an alternative embodiment, a casino gaming system may comprise any combination of one or more network bridges and one or more network racks.

The back end system 112 may be configured to comprise one or more servers. The type of server employed is generally determined by the platform and software requirements of the gaming system. In one embodiment, as illustrated in FIG. 7, the back end system 112 is configured to include three servers: a slot floor controller 114, a casino management server 116 and a casino database 118. The slot floor controller 114 is a part of the player tracking system for gathering accounting, security and player specific information. The casino management server 116 and casino database 118 work together to store and process information specific to both employees and players. Player specific information includes, but is not limited to, passwords, biometric identification, player card identification, and biographic data. Additionally, employee specification information may include biographic data, biometric information, job level and rank, passwords, authorization codes and security clearance levels.

Overall, the back end system 112 performs several fundamental functions. For example, the back end system 112 can collect data from the slot floor as communicated to it from other network components, and maintain the collected data in its database. The back end system 112 may use slot floor data to generate a report used in casino operation functions. Examples of such reports include, but are not limited to, accounting reports, security reports, and usage reports. The back end system 112 may also pass data to another server for other functions. Alternatively, the back end system 112 may pass data stored on its database to floor hardware for interaction with a game or game player. For example, data such as a game player's name or the amount of a ticket being redeemed at a game may be passed to the floor hardware. Additionally, the back end system 112 may comprise one or more data repositories for storing data. Examples of types of data stored in the system server data repositories include, but are not limited to, information relating to individual player play data, individual game accounting data, gaming device accounting data, cashable ticket data, and sound data including optimum audio outputs for various casino settings.

Of course, one will appreciate that a gaming system 100 may also comprise other types of components, and the above illustrations are meant only as examples and not as limitations to the types of components or games used in a casino gaming system capable of presenting a responsible gaming message.

The main cabinet 12 of the gaming device houses a game monitoring unit (not shown) that includes a CPU, circuitry, and software for receiving signals from the player-activated buttons 13 and/or a handle 15, operating the games, and transmitting signals to the respective game display 17 and speakers 19. The game monitoring unit is a device that is connected to the circuitry of the gaming device that monitors the game, coin status, player winnings, and other functions of the gaming device. The game monitoring unit also sends the monitored information to a backend server for processing.

In various embodiments, the game program may be stored in a memory (not shown) comprising a read only memory (ROM), volatile or non-volatile random access memory (RAM), a hard drive or flash memory device or any of several alternative types of single or multiple memory devices or structures.

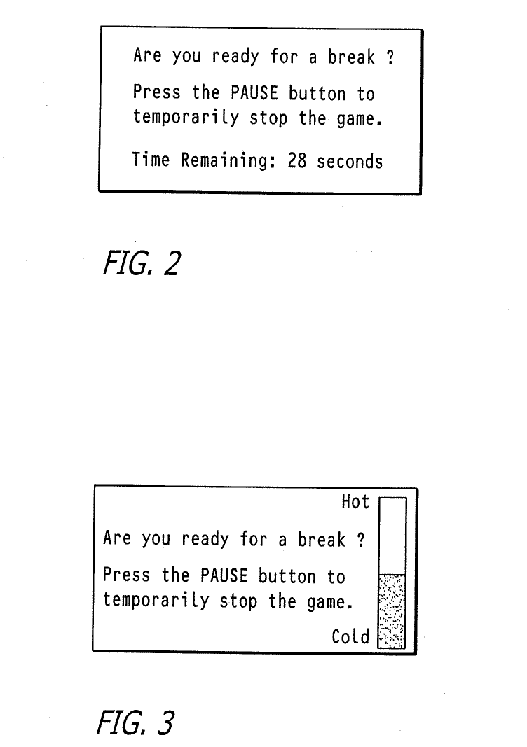

According to one embodiment, the gaming monitoring unit (not shown) includes a responsible gaming module 30. In one embodiment, the responsible gaming module is a software program that presents a message to the player in response to a trigger event such as, but not limited to, a predetermined duration of a gaming session, number of games, amount wagered, or any combination thereof. Generally, the responsible gaming module presents a message to a player on the main display, secondary display, or any combination thereof. For example, as shown in FIG. 2, the message is a friendly reminder such as “You've been playing for a while—maybe you should take a break.” As those skilled in the art will appreciate, any message that suggests that the player take a break or end a gaming session is contemplated. In other embodiments, the message may include animation, graphics, movie clips, sound effects, music, or any combination thereof.

As a part of the game monitoring unit, the responsible gaming module 30 is able to access information from the game monitoring unit (e.g., coin in and coin out). The responsible gaming module 30 is then able to present a responsible gaming message based upon a particular coin in or coin out value. For example, the responsible gaming module 30 will present a responsible message to the player if the player has won or lost $500 or any other amount of money predetermined by a gaming establishment or the player. That is, the player's win or loss limits may be associated with the player's account or the gaming device will prompt the player for their win or loss limits prior to initiating the gaming session.

Alternatively, the responsible gaming module 30 accesses the game monitoring unit and presents a “win meter” as shown in FIG. 3. The win meter is tied to the performance of the gaming device and is a graphical representation of the payout of the gaming device. If the gaming device has not recently paid out, the win meter is low. If the gaming device has been paying out multiple wins, the win meter may reflect a higher level. Accordingly, the win meter may be used to provide more information to the player and allow the player to make an informed decision regarding his/her wager. Accordingly, in this embodiment, the responsible gaming module 30 may present a responsible gaming message in response to one or more levels on the win meter.

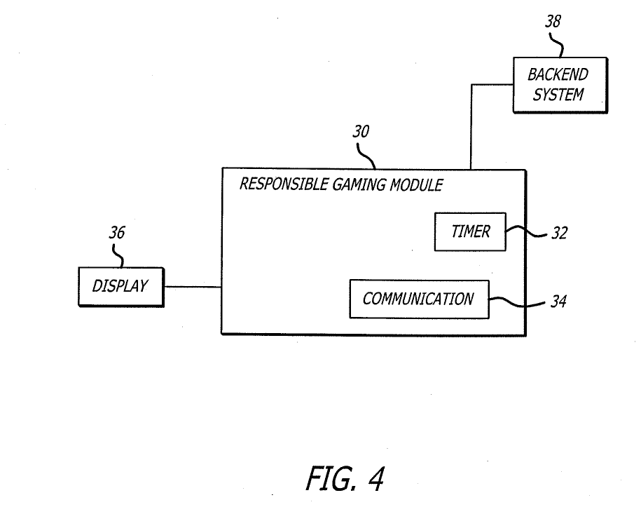

In another embodiment, the responsible gaming module 30 is a combination of hardware and software as shown in FIG. 4. The responsible gaming module 30 may include a timer 32 (or other time keeping device or methodology), a communication means 34 (e.g., Ethernet, Internet, phone (landline or cellular), a dedicated display 36, connections and access to one or more backend systems 38 (e.g., player tracking system), or any combination thereof.

Generally, the timer 32 is initiated once the gaming session has begun, and the responsible gaming message presents a message to a player after a predetermined period(s) of time. For example, a message is presented to a player every sixty minutes. Alternatively, the responsible gaming module 30 increases the frequency (and optionally the urgency) of the messages over time. The responsible gaming module 30 includes programming to stop the timer 32 after periods of inactivity and/or resume once gaming continues. Furthermore, the timer 32 resets after a gaming session has terminated and/or after a predetermined length of time of inactivity. In another embodiment, the timer 32 also is used to countdown the time during a player-initiated break (e.g., a countdown from one minute).

Optionally, the responsible gaming module 30 includes an Ethernet and/or Internet connection 34. According to one embodiment, when a trigger event has occurred, the responsible gaming module 30 sends a message (e.g., text, electronic mail, short message service (SMS), Voice over Internet Protocol (VoIP)) to a central casino computer or server (not shown) in addition to presenting a responsible gaming message on the gaming device 10. As a result, the casino employee may visit the player and check on the player. This personal touch may be beneficial to forging a relationship with a casino patron, especially a high roller. Furthermore, the casino employee may also be able to market a promotion or present the player with an award. In another embodiment, one or more contacts on the player's profile are sent a message (e.g., text or SMS). Optionally, the responsible gaming module 30 initiates a call (e.g., VoIP) to one or more of the player's contacts. An automatic voice (message) system or a “live” person may initiate the call to the player's contacts. In yet another embodiment, a casino employee or player contact may initiate a “call” (VoIP) to the gaming device 10. In this embodiment, the gaming device 10 includes a microphone (not shown) to facilitate the call.

In another embodiment, the responsible gaming module 30 is in communication with one or more of the displays 16, 17 of the gaming device 10. The responsible gaming message may be presented on the main video display 17, a secondary display 16 in the main cabinet 12 or top box 14, a display (not shown) associated with a player tracking system, or any combination thereof. According to one embodiment, the responsible gaming module is a component of a user interface display as disclosed in U.S. patent application Ser. No. 10/943,771 entitled “User Interface System and Method for a Gaming Machine” filed on Sep. 16, 2004, which is hereby incorporated by reference. In this embodiment, the responsible gaming module uses the processor associated with the user interface display to manage the presentation of a responsible gaming message on a gaming device. Additionally, the processor of the user interface display manages the presentation of responsible gaming message on one or more may be in communication with other user interface displays or other displays on other gaming devices.

In yet another embodiment, the responsible gaming module is a component of a backend system or server such as, but not limited to, a player tracking system or a slot management system. In another embodiment, the responsible gaming module is a separate system that is in communication with one or more backend systems as well as the game monitoring units of one or more gaming devices.

In those embodiments having the responsible gaming module in communication with the player tracking system, the responsible gaming module is able to customize the messages presented to the player by obtaining player information from the player tracking system. For example, the responsible gaming message is customized with the player's name. Alternatively, the trigger event(s) for the presentation of a responsible gaming message to a player is tailored to the player's profile (e.g., high roller or beginning player). For example, a responsible gaming message is presented to the player after one hour of game play whereas the default time for a responsible gaming message is thirty minutes. Alternatively, for example, a responsible gaming message is presented to the player based upon the player's set criteria such as, but not limited to, a win limit of $600 or a loss limit of $200. Accordingly, the responsible gaming message presents messages to the player when the player approaches and/or achieves either win or loss limit.

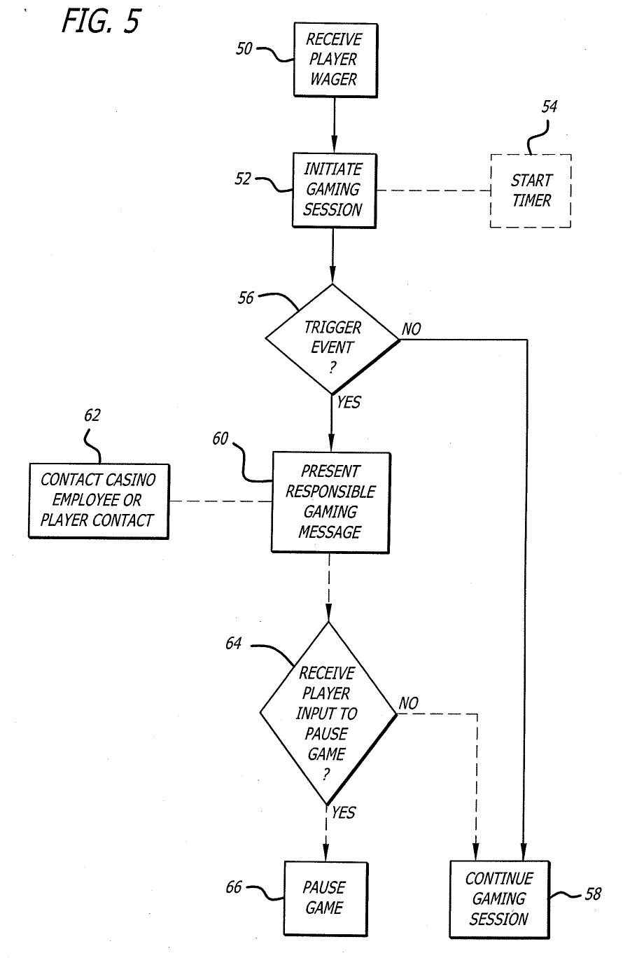

In addition to various embodiments of a responsible gaming device, various methods for promoting responsible gaming are disclosed herein. According to one method, as shown in FIG. 5, a gaming device receives a player wager at step 50, and a gaming session is then initiated at step 52. Optionally, at step 54, the responsible gaming module 30 starts a timer 32 once the player initiates the gaming session. At step 56, the responsible gaming module 30 determines whether a trigger event has been established. The trigger event may be a predefined duration of time (set by a gaming establishment operator or the player), win amount, or loss amount. If a triggering event has not been established, the gaming session continues (step 58) so long as the player has sufficient credits to wager on a game. If a triggering event is detected, a responsible gaming message is presented to the player at step 60.

Optionally, once the responsible gaming message has been presented to the player at step 60, the responsible gaming module 30 provides the player with a choice to pause or to end the gaming session. For example, a message such as “Are you ready for a break? Press the pause button to temporarily stop the game” is presented to the player. At step 64, if the gaming device does not receive any player input within a specified period of time or declines to take a break, the gaming session continues at step 58. Otherwise, the gaming device pauses the gaming session at step 66.

The gaming session is then paused for a predefined period of time. Alternatively, the gaming device 10 provides the player with the option to activate (e.g., push) a pause button or to activate another input means to set the duration of the break (e.g., each time the pause button is activated adds a 30 second break). Furthermore, the responsible gaming module 30 may allow the player to terminate the player-selected break and resume gaming by depressing one or more buttons on the gaming device. Alternatively, the player ends the gaming session or the break session by cashing out any remaining credits on the gaming device.

Optionally, at step 62, the responsible gaming module 30 contacts a casino employee and/or a player contact. The casino employee and/or the player contact are notified that a responsible gaming message has been presented to the player.

Additionally, the responsible gaming module 30 may include programming to lock-up or otherwise suspend game play after a predetermined number of responsible gaming messages. The player is then forced to take a break for a predefined period of time as set by a gaming establishment or, alternatively, the player may select the duration of the forced break. Once the break is completed, the gaming session resumes. Alternatively, a gaming establishment employee is required to unlock the gaming device 10. In yet another embodiment, the responsible gaming module 30 locks-up the gaming device 10 and cashes out any credits remaining on the gaming device to the player.

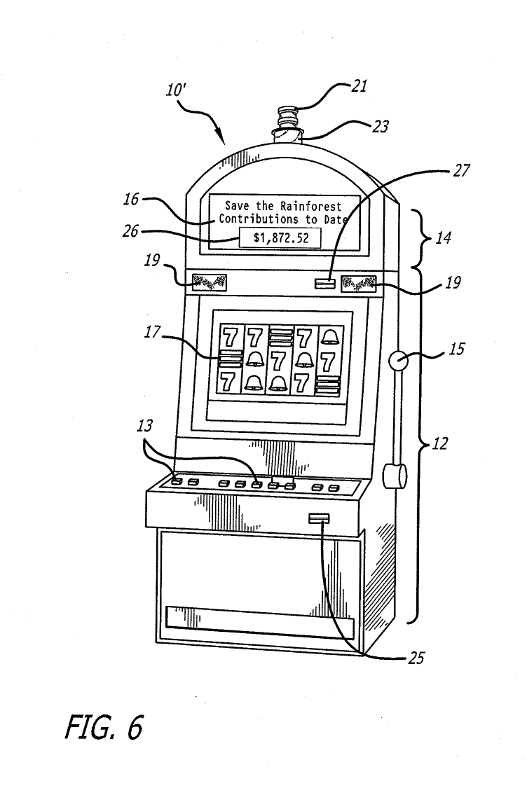

In a different embodiment of a responsible gaming device 10′, the gaming device includes a program module (not shown) that manages a charitable donation pool, as shown in FIG. 6. The program module provides the player with the option to donate a portion of the player's wager to one or more charities. Optionally, the player is allowed to determine the percentage of his/her wager that is donated to charity. Alternatively, the percentage of the player's wager contributed to a charity is preset by the gaming establishment or gaming manufacturer. In yet another embodiment, a portion of any winning outcome in a primary game or a bonus game may be contributed to one or more charities. The portion of the winning outcome may be preset by the gaming establishment or selected by the player before or after the winning outcome.

The total contribution amount may be presented on a display 26 of the gaming device 10′, as shown in FIG. 6, or as a running total of the gaming session. Optionally, a display sign (not shown) that is associated with a bank of gaming devices may present the total of contributions to a charity from a plurality of gaming devices. Alternatively, the total contributions to a particular charity may also be presented on a display of the gaming device 10′. According to one embodiment, the contributions to the charity are presented in real-time on a gaming device display 26 and/or a shared game display.

Additionally, the responsible gaming device 10′, as shown in FIG. 6, is associated with a printer (not shown). The printer may be located on the gaming device 10′, a kiosk associated with a bank of gaming devices, or a printer at a remote location from the gaming devices. The printer is configured to print out tax receipts for the player's gaming session. Optionally, the player may request that any tax receipts be mailed (either electronically or via paper) to the player. The player may use a keypad, touch screen, virtual keyboard as disclosed in U.S. patent application Ser. No. 11/620,363, filed Jan. 5, 2007, entitled “Gaming Machine with a Virtual Interface,” which is hereby incorporated by reference, or other input devices to input address information.

In another embodiment, a responsible gaming system (not shown) is adapted to communicate with one or more gaming devices. The responsible gaming system funds and manages the charity pool. For example, the charity pool may be funded with seed money from the casino, bonus points, and/or marketing dollars. Alternatively, the charity pool is funded with a portion of the player's wagers and/or winnings. According to one embodiment, the responsible gaming system is configured so that any contribution by the player is matched by the gaming establishment. The matching amount or matching period of time may be set by the casino temporarily or as a permanent feature of the gaming devices. Alternatively, the matching contributions of the gaming establishment are initiated in response to a triggering event established by the responsible gaming system. In another embodiment, a winning event of a bonus game is the casino operator contributing to the charity.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A method for presenting one or more responsible game messages pertaining to a player of a gaming device of the type having a display, an associated game input device for the player to interact with the processor to control game play and in connection with a system for tracking at least the wagering activity, said method comprising:
connecting a communication unit to the gaming device for providing communication between the gaming device and a back-end server over a communication network and with networks providing one or more of Internet or cellular phone communication;
monitoring the functions of the gaming device including the player's gaming activities at one or more of said unit and said server;
programming at least one of said unit and server to define a responsible gaming module;
configuring said module to define a responsible gaming message trigger condition for said player, said trigger condition related to the player's gaming activities;
upon said trigger condition being met, said module issuing a responsible gaming message through at least one or more of said cellular telephone or Internet communication networks to one or more recipients.

2. The method of claim 1 comprising configuring said unit to accept inputs from a player's portable communication device selected from a group including a cellular telephone and personal data assistant (PDA).

3. The method of claim 1 comprising identifying one or more player contacts and upon said trigger condition being met said module issuing a responsible gaming message to one or more identified player contacts.

4. The method of claim 3 comprising upon said triggering condition being met said module sending at least one of at least an email, short message service (SMS) message or Voice over Internet Protocol (VoIP) message to one or more identified player contacts.

5. The method of claim 1 comprising connecting a user interface display device as said unit to said gaming device and programming one or more of said user interface display device and said server to define said responsible gaming module.

6. The method of claim 1 comprising connecting a gaming monitoring module (GMU) as said unit to said gaming device and programming said (GMU) for monitoring the functions of the gaming device including the player's gaming activities and to define a responsible gaming module.

7. The method of claim 1 comprising configuring said module to define a responsible gaming message trigger condition including one or more conditions of gaming session duration, number of games played, coin in, coin out or amount wagered.

8. The method of claim 1 comprising configuring said module to display a responsible gaming message at said display upon said triggering condition being met.

9. The method of claim 1 comprising configuring said unit to display to the player a graphical representation of gaming device win performance.

10. The method of claim 1 comprising configuring said unit to issue a signal with said message to disable said gaming device.

11. The method of claim 1 comprising configuring said module for issuing a responsible gaming message through at least one or more of said cellular telephone or Internet communication networks to one or more recipients selected from the group consisting of said player, casino personnel and player designated contacts.

12. In a system including a plurality of gaming devices each having a display, a back-end server and a communication network to provide communication between the gaming devices and the server and where the server includes a database of players, a method for presenting one or more responsible game messages pertinent to a player comprising:
connecting a communication unit to each gaming device for providing communication between the gaming device and the back-end server over said communication network and with networks providing one or more of Internet or cellular phone communication;
providing for the monitoring of the functions of the gaming device including the player's gaming activities;
programming at least one of said unit and server to define a responsible gaming module;
configuring said module to define a responsible gaming message trigger condition for said player, said trigger condition related to the player's gaming activities;
upon said trigger condition being met based upon said monitoring, said module issuing a responsible gaming message through at least one or more of said cellular telephone or Internet communication networks to one or more recipients.

12. A method for presenting one or more responsible game messages to a player of a gaming device of the type having a display, an associated game input device for the player to interact with the processor to control game play and in connection with a system for tracking at least the wagering activity, said method comprising:
connecting a communication unit to the gaming device for providing communication between the gaming device and a back-end server over a communication network and with networks providing one or more of Internet or cellular phone communication;
enabling said unit to accept inputs from a player's portable communication device selected from a group including a cellular telephone and personal data assistant (PDA). monitoring the functions of the gaming device including the player's gaming activities with one or more of said unit and server;
programming at least one of said unit and server to define a responsible gaming module;
configuring said module to define a responsible gaming message trigger condition for said player, said trigger condition related to the player's gaming activities;
identifying one or more player contacts and upon said trigger condition being met said module issuing a responsible gaming message to one or more identified player contacts;
upon said trigger condition being met, said module issuing a responsible gaming message through at least one or more of said cellular telephone or Internet communication networks to said player and one or more of said player contacts.
